(19) United States
(12) Patent Application Publication
(10) Pub. No.: US 2022/0268029 A1
(43) Pub. Date: Aug. 25, 2022

(54) A SOUND TUNING LAYER AND A PANEL FOR ACOUSTIC TREATMENT OF A SPACE

(71) Applicant: VISOUND ACÚSTICA SA, Cnrvalhosa Paços De Ferreira (PT)

(72) Inventor: César Manuel BARRAS CARAPINHA, Carvalhosa Paços De Ferrira (PT)

(21) Appl. No.: 17/628,241

(22) PCT Filed: Jul. 22, 2020
(86) PCT No.: PCT/IB2020/056907

§ 371 Date: Jan. 19, 2022

(30) Foreign Application Priority Data
Jul. 23, 2019 (PT) 115665
Jul. 31, 2019 (EP) 19189489.8

(51) Int. Cl. E04F 13/08; B41M 5/035; G10K 11/168; E04B 1/86; E04B 9/04; F21V 33/00

(52) U.S. Cl. CPC E04F 13/0867; B41M 5/035; G10K 11/168; E04B 1/86; E04B 9/045; F21V 33/0052

(57) ABSTRACT

The present invention is enclosed in the area of acoustic treatment, therefore solutions for adapting/tuning the acoustic performance of a space, wherein such space may take very varied forms: a living space such as a living or sleeping room (100), a lobby or a recording room (100). It is an object of the present invention a sound tuning layer which is PE based and obtained from the steps of sublimation of a PE based starting material with an open cell structure, and subsequent cold pressing, said cold pressing being performed at a lower temperature as regards the sublimation step, and while the sublimated sound tuning layer is still hot, and thereby forming the sound tuning layer, with an open cell structure. It therefore provides a more environmentally friendly and simple solution than those of prior art.

### FIELD OF THE INVENTION

The present invention is enclosed in the area of acoustic treatment, therefore solutions for adapting/tuning the acoustic performance of a space, wherein such space may take very varied forms: a living space such as a living or sleeping room, a lobby, office, restaurant, auditorium, school or a recording room. Such space therefore requires specific solutions which take into consideration several elements from acoustic treatment to simplicity of construction and/or appearance.

### PRIOR ART

Typically, in order to provide for the acoustic treatment of a space, several elements are combined, wherein one of the most common solutions is using a printed acoustic panel.

The standard process for getting a printed acoustic panel involves printing a fabric and then glue it to an acoustic foam.

This standard procedure therefore includes several raw materials: fabric and glue, which complicates the process and has a high environmental impact.

Another solution includes UV printing of a sound absorbing panel made of a material such as PET, which is highly effective as regards printing, but leads to the closure of the cells formed at least in the surface of the panel due to an ink cover formed in such surface, which affects the sound absorbing performance of the panel, as the ink cover produces the closure of the cells, leading to the reflection of sound in the panel.

The present solution innovatively overcomes such issues.

### SUMMARY OF THE INVENTION

It is therefore an object of the present invention a sound tuning layer which is polyethylene (PE) or polyethylene terephthalate PET based and obtained from the following steps:
sublimation of a PE or PET based starting material with an open cell structure, such sublimation comprising pressing a PE based starting material under heat and pressure, against a sublimation transfer support content, thereby obtaining a sublimated sound tuning layer, and
subsequent cold pressing, said cold pressing being performed at a lower temperature as regards the sublimation step, and while the sublimated sound tuning layer is still hot, and thereby forming the sound tuning layer, maintaining an open cell structure.

Such solution provides for a new product which, by using a PE based starting material with an open cell structure, which may also be referred to as an open cell raw material—for instance PET wool or foam, such as the VicPet Wool—and by condensing the process in two steps: sublimation and subsequent cold pressing, provides for an innovative solution which allows to dye while avoiding the use of fabric and glue. It therefore results in a process that doesn't compromise the raw material's acoustic properties and that is a more environmentally friendly and simple solution than those of prior art. In addition, the subsequent cold pressing, which is performed at a lower temperature as regards the sublimation step and while the sublimated sound tuning layer is still hot, provides that the hot sublimated panel is cooled, thereby maintaining its sublimated shape and avoiding the formation of a corrugated surface in the PE/PET material, which would increase the roughness of the panel. Thus, a panel obtained through this procedure has a smoother finishing surface.

It is also an object of the present invention a panel for acoustic treatment of a space, which comprises at least one sound tuning layer of the present invention, according to any of its embodiments.

The sound tuning layer and any panel for acoustic treatment which comprises are such that provide acoustic treatment of medium and high frequencies at the same time. The solution of the present invention therefore doesn't compromise the acoustic properties of the layer and reduces the use of raw materials (no need for fabric nor glue), and is more environmentally friendly than the standard printed panels known in the art.

With the sublimation step and subsequent press step, preferably a cold press, the sound tuning layer of the present invention can used to create several different acoustic panels, with different thicknesses, densities, textures and that can simulate any real material like stones, marbles or assume any pattern/design.

It is also an object of the present invention a covering panel for a structure of a living space comprising the panel for acoustic treatment of a space of the present invention, in any of its described embodiments, such structure of a living space preferably consisting of a wall or a ceiling, and the cover thereby consisting of a wall or ceiling cover, such as a wallpaper. In an alternative embodiment, the present invention comprises a panel for a living space comprising the panel for acoustic treatment of a space of the present invention, in any of its described embodiments wherein, preferably, the panel is suitable to be suspended in a structure of a living space, such structure preferably consisting of a wall or a ceiling, and the cover thereby being suitable to be suspended or fixed o such structure.

Moreover, it is also an object of the present invention a lighting structure comprising the panel for acoustic treatment of the present invention, in any of its described embodiments, the panel covering at least partially a lighting element of the lighting structure. Thus, such lighting structure provides sound tuning in a surface under which a light is provided while also allowing light to pass, and thereby maintain both functionalities. The lighting structure may contain a lighting element such as a light bulb or merely be positioned adjacently to a window, and thereby let light—for instance from the sun or any other light source—to cross it. Preferably, the panel for acoustic treatment is obtained with a sublimation transfer support content which consists of sublimation paper, the sublimation paper having no ink and thereby provides a white sublimated sound tuning layer, which lets light pass without changing the colour of the light.

### DESCRIPTION OF FIGURES

FIG. 1—representation of an embodiment of the panel for acoustic treatment of a space of the present invention, in such case presenting a top view of a room (100) in which the panel of the present invention is a flat panel, has two sound tuning layers and is placed along one of the walls (101) of the room (100). The first sound tuning layer (11) faces the interior of the room (100) and has a higher density than the second sound tuning layer (12), which is facing the wall (101) of the room (100). Such solution provides for an enhanced acoustic performance.

FIG. 2—representation of an embodiment of the panel for acoustic treatment of a space of the present invention, in such case presenting a side view of a room (100) in which the panel of the present invention has two sound tuning layers and is placed near the ceiling of the room (100). The first sound tuning layer (11) faces the interior of the room (100) and has a higher density than the second sound tuning layer (12), which is facing the wall (101) of the room (100). Such solution provides for an enhanced acoustic performance. Moreover, where the first and second sound tuning layers (12) are transparent, a lighting structure may be placed above the panel and provide for both the acoustic treatment of such portion of the room (100) while letting light to pass from the lighting element to the inside of the room (100).

FIG. 3—in an embodiment of the covering panel according to the present invention, a plurality of panels is suitable to be provided in a wall (101), the panels having a rectangular configuration and being attachable to other panels by means of a straight bar. Such embodiment is represented in FIG. 3, wherein each individual panel was sublimated such that it has a marble pattern.

FIG. 4—representation of an embodiment of the suspended panel of the present invention, similarly to the representation of FIG. 2. In the panel of FIG. 3 several hanging elements, which include wires and coupling elements, are represented, in order to suspend the panel in a structure such as the ceiling of a space.

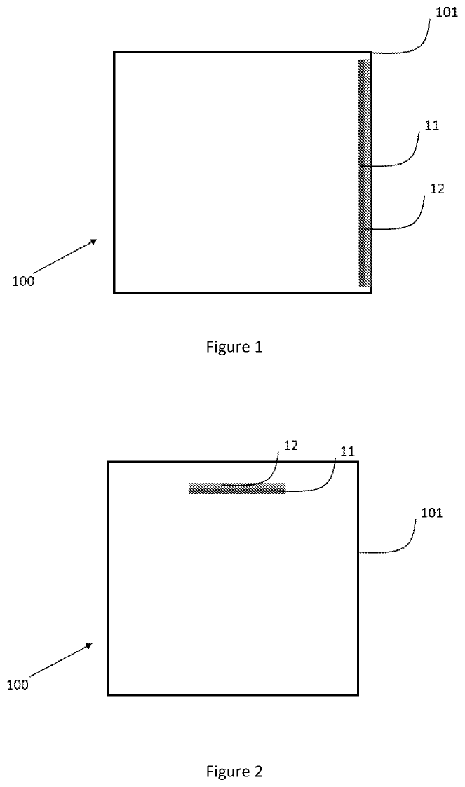

### DETAILED DESCRIPTION

The more general and advantageous configurations of the present invention are described in the Summary of the invention. Such configurations are detailed below in accordance with other advantageous and/or preferred embodiments of implementation of the present invention.

In an advantageous embodiment of the sound tuning layer of the present invention, the sublimation is performed at a pressure, temperature and/or time such that the cell structure of the PE based material of the sublimated sound tuning layer is not closed, whereby the raw material open cell structure is maintained, i.e. without blocking its porous structure during the dyeing process. Such may also be referred as providing that the spacing between fibres of the PE based material of the sublimated sound tuning layer is not closed. Such detail allows for a better sound tuning performance, as the acoustic properties of the PE based material of the sublimated sound tuning layer are maintained.

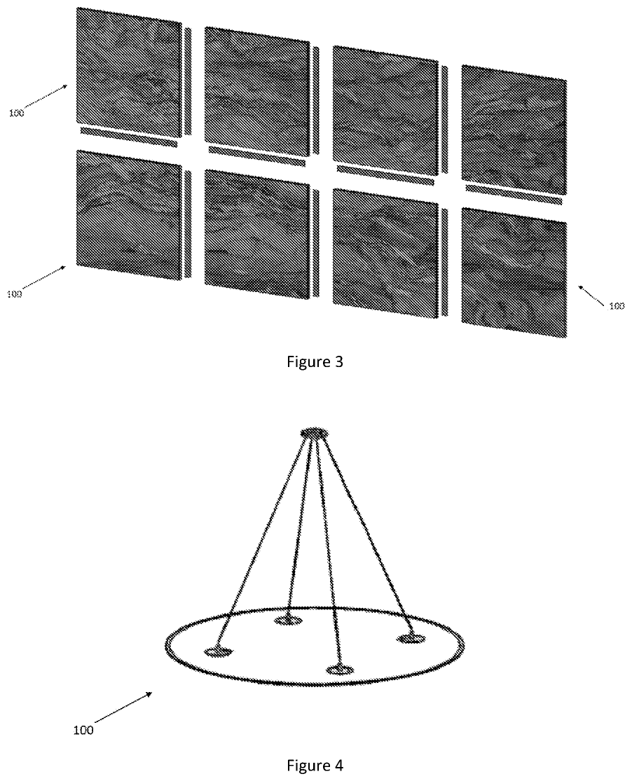

In another inventive aspect of the sound tuning layer of the present invention, the pressing is performed with a press comprising a pattern, and thereby the pressing providing thermoforming of the sound tuning layer with said pattern, preferably such thermoforming being performed on only one of the sides of the layer. Such solution provides that the steps of shaping and thermoforming are simultaneously performed, resulting in a more efficient process and enhanced thermoforming. Such thermoformed side of the layer will, in a working arrangement, be facing a space to be tuned. The pattern may consist of an image of a real element, such as rock (for instance, marble, as of the embodiment of FIG. 3), wood, concrete, or another.

In addition, it another advantageous embodiment of the sound tuning layer of the present invention, the sublimation transfer support content consists of sublimation paper, the sublimation paper preferably having:
at least one ink of at least one colour, more preferably having a pattern, or
no ink, and thereby providing a transparent sublimated sound tuning layer.

Where the sublimation paper comprises at least one ink of at least one colour, the sublimation step allows for the transfer of such ink to the PE based starting material, forming the sublimated sound tuning layer. Where the sublimation paper comprises also a pattern, such pattern is thereby transferred to the PE based starting material. Preferably, the at least one ink of at least one colour is an OECOTEX Passport certified ink.

Where the sublimation paper has no ink, a transparent sublimated sound tuning layer is provided. Such solution is particularly useful when in connection with lighting elements, by letting the light pass and maintain the acoustic/sound tuning properties.

In yet another inventive aspect of the sound tuning layer of the present invention, its density is adapted to a higher value, in such case being obtained through a higher pressure in the cold press step and/or a higher density of the PE based starting material with an open cell structure, or to a lower value, in such case being obtained through a lower pressure in the cold press step and/or a lower density of the PE based starting material with an open cell structure. Therefore, by means of adaptations to the pressure of the cold press step and/or the density of the PE based starting material with an open cell structure, the density of the obtained sound tuning layer is adapted. It therefore maintains the simple construction of the procedure through which the sound tuning layer of the present invention is obtained.

In addition, where the density is adapted to a higher value, the density of the PE based starting material with an open cell structure is of 1300-1800 g/m² and/or, where the density is adapted to a lower value, the density of the PE based starting material with an open cell structure is of 600-1000 g/m². Such density values may be converted on g/m³ by means of the thickness of the layer.

Preferably, the PE based starting material consists of polyethylene terephthalate (PET). Moreover, the PET based starting material consists of an open cell PET based material, preferably comprising processed PET bottles, more preferably said processing includes milling and/or melting. The obtained solution is therefore using as starting material a previously processed material, PET bottles, which are processed for the purpose of the present invention by milling and/or melting.

It may also be mentioned that the referred starting material of the present invention is suitable for certified as Class 1 according to OEKO-TEX standard, i.e. meeting the human-ecological requirements presently established for baby articles. In addition up to 65% of the new raw material fibers comes from recycling material (PET bottles) and in the end of life the panel can be 100% recycled. As previously referred, the ink used in the sublimation step is also certified according to OEKO-TEX passport.

Preferably, each sound tuning layer has a thickness of 1-50 mm.

In an inventive aspect of the panel for acoustic treatment of the present invention, it comprises two sound tuning layers adjacently positioned: a first sound tuning layer (11) with a higher density and a second sound tuning layer (12) with a lower density, wherein, in a working arrangement, the first sound tuning layer (11) faces the interior of a space to be tuned. It therefore provides for an enhancement of the sound tuning properties of the panel, as it allows for the creation of an acoustic membrane at the surface of the panel, by means of the higher density of the surface which will face a living space to be acoustically treated/tuned. It provides for a better acoustic performance of the panel for acoustic treatment of a space. Preferably, each two adjacently positioned layers are bonded by means of a friction process, thereby providing that the fibres of a layer entangle the fibres of the other layer.

In addition, the panel may consist of a flat panel, in which case:
it is smooth and has a thickness of 20-40 mm and/or a density of 35-80 kg/m³, preferably 40-80 kg/m³, or
it is textured and has a thickness of 5-10 mm and/or a density of 80-200 kg/m³, preferably 80-160 kg/m³.
   therefore allowing for the creation of different types of surface of the panel. In a working arrangement, the smooth or textured surface faces a space to be tuned.

As will be clear to one skilled in the art, the present invention should not be limited to the embodiments described herein, and a number of changes are possible which remain within the scope of the present invention.

Of course, the preferred embodiments shown above are combinable, in the different possible forms, being herein avoided the repetition all such combinations.

1. A sound tuning layer characterised in that it is polyethylene (PE) or polyethylene terephthalate (PET) based and obtained from the following steps:
sublimation of a transfer support content in a PE or PET based starting material with an open cell structure, such sublimation comprising pressing a PE or PET based starting material under heat and pressure, against a sublimation transfer support, thereby obtaining a sublimated sound tuning layer, and
subsequent cold pressing, said cold pressing being performed at a lower temperature as regards the sublimation step, and while the sublimated sound tuning layer is still hot, and
thereby forming the sound tuning layer, maintaining an open cell structure.

2. A layer according to claim 1 wherein the sublimation is performed at a pressure, temperature and/or time such that the open cell structure of a PE based material of the sublimated sound tuning layer is not closed.

3. A layer according to claim 1 wherein the cold pressing is performed with a press comprising a pattern, and thereby the cold pressing providing thermoforming of the sound tuning layer with said pattern, preferably such thermoforming being performed on only one of the sides of the layer.

4. A layer according to any of claim 1 wherein the sublimation transfer support consists of sublimation paper, the sublimation paper preferably having:
at least one ink of at least one colour, more preferably having a pattern, or
no ink, and thereby providing a white sublimated sound tuning layer.

5. A layer according to claim 4 wherein said sublimation step is performed with a certified ink.

6. A layer according to claim 1 wherein its density is adapted to a higher value, in such case being obtained through a higher pressure in the cold press step and/or a higher density of the PE based starting material with an open cell structure, or to a lower value, in such case being obtained through a lower pressure in the cold press step and/or a lower density of the PE based starting material with an open cell structure.

7. A layer according to claim 6 wherein, where the density is adapted to a higher value, the density of the PE based starting material with an open cell structure is of 1300-1800 g/m³ and/or, where the density is adapted to a lower value, the density of the PE based starting material with an open cell structure is of 600-1000 g/m².

8. A layer according to claim 1 wherein the PET based starting material consists of an open cell PET based material, preferably comprising processed PET bottles, more preferably said processing includes milling and/or melting.

9. A layer according to claim 1 wherein each sound tuning layer has a thickness of 1-50 mm.

10. A panel for acoustic treatment characterised in that it comprises at least one sound tuning layer according to claim 1.

11. A panel according to claim 10 wherein it comprises two sound tuning layers adjacently positioned: a first sound tuning layer (11) with a higher density and a second sound tuning layer (12) with a lower density, wherein, in a working arrangement, the first sound tuning layer (11) faces the interior of a space to be tuned and, preferably, each two adjacently positioned layers are bonded by means of a friction process.

12. A flat panel according to claim 10, wherein:
it is smooth and has a thickness of 20-40 mm and/or a density of 35-80 kg/m³, preferably 40-80 kg/m³, or
it is textured and has a thickness of 5-10 mm and/or a density of 80-200 kg/m³, preferably 80-160 kg/m³.

13. A panel according to claim 11, wherein:
the panel is a covering panel for a structure of a living space, wherein such structure preferably consisting of a wall (101) or a ceiling, and the covering panel thereby consisting of a wall (101) or ceiling cover, or
the panel is suitable to be suspended in a structure of a living space, such structure preferably consisting of a wall (101) or a ceiling, and the covering panel thereby being suitable to be suspended or fixed o such structure.

14. A lighting structure comprising a panel according to claim 11, the panel covering at least partially a lighting element of the lighting structure wherein, preferably, the panel is obtained with a sublimation transfer support which consists of sublimation paper, the sublimation paper having no ink and thereby providing a white sublimated sound tuning layer.
